(19) United States
(12) Patent Application Publication
(10) Pub. No.: US 2011/0064631 A1
(43) Pub. Date: Mar. 17, 2011

(54) HYDROGEN GENERATOR AND THE APPLICATION OF THE SAME

(76) Inventors: Min-Hon Rei, Kweishang (TW); Shih-Chung Chen, Kweishang (TW); Sheng-Yuan Yang, Kweishang (TW); Yu-Lin Chen, Kweishang (TW); Guan-Tyng Yeh, Kweishang (TW); Chia-Yeh Hung, Kweishang (TW); Yu-Ling Kao, Kweishang (TW)

(21) Appl. No.: 12/640,487

(22) Filed: Dec. 17, 2009

(30) Foreign Application Priority Data
Sep. 14, 2009 (TW) 098130886

(51) Int. Cl. B01J 10/00; B01J 19/00

(52) U.S. Cl. 422/627; 422/198

(57) ABSTRACT

A hydrogen generator essentially composed of a first medium is provided, comprising: a reforming zone, a preheating zone and a heat source. The reforming zone is used for containing a reforming catalyst so as to perform a steam reforming reaction of a hydrogen-producing raw material to generate hydrogen; and the heat source provides heat to the preheating zone and reforming zone, so that the hydrogen-producing raw material is firstly preheated in the preheating zone and then performs the steam reforming reaction in the reforming zone. The reforming zone and preheating zone are divided with a shortest interval of at least about 0.5 mm with the first medium, wherein the first medium has a thermal conductivity (K) of at least about 60 W/m-K.

### CROSS-REFERENCES TO RELATED APPLICATIONS

This application claims priority to Taiwan Patent Application No. 098130886, filed on Sep. 14, 2009, the contents of which are herein incorporated by reference in its entirety.

### BACKGROUND OF THE INVENTION

1. Field Of the Invention

The present invention relates to a hydrogen generator, and more particularly, to a hydrogen generator for providing a hydrogen-containing gaseous mixture with low carbon monoxide (CO) content and the application thereof.

2. Descriptions of the Related Art

Hydrogen is an important fuel source for many energy conversion devices. For example, fuel cells renowned as a “green environment-friendly power generator” just use high purity hydrogen as a fuel for reacting with oxygen (or the air) to generate power by converting the chemical energy directly into the electric energy.

A conventional method of producing hydrogen that is commonly used is the steam reforming reaction (SRR) in which, at the presence of an SRR catalyst, steam reacts with alcohols (e.g., methanol, ethanol, and etc) or hydrocarbons (e.g., methane, hexane, and etc) to generate a desired hydrogen-containing gaseous mixture. Because SRR is an endothermic reaction, a heat source must be available to provide heat necessary for the reaction. For example, the heat necessary for the reforming reaction may be provided by using an oxidizing catalyst to catalyze an exothermic oxidizing reaction in a reforming reactor.

Typically, the reforming catalyst for the SRR also catalyzes the water gas shift reaction (WGSR), i.e., an exothermic reaction shown as follows in the rightward direction:

CO+H₂O⇄CO₂+H₂

Hence, a higher temperature of the catalyst bed in the reforming reactor (i.e., a hot zone present in the catalyst bed) is more favorable for inhibiting the WGSR (i.e., CO+H₂O→CO₂+H₂), causing CO₂ and H₂ generated from the reforming reaction to be transformed into CO and H₂O; conversely, a lower temperature is more favorable for promoting the WGSR, resulting in further reduced concentration of CO and increased concentration of H₂. However, as described above, the SRR is an endothermic reaction, so the reaction rate and the conversion extent of the SRR will be reduced if the temperature of the catalyst bed in the reforming reactor is too low (i.e., a cold zone present in the catalyst bed).

Taking a methanol steam reforming reaction as an example, in the presence of a reforming catalyst such as copper-zinc catalyst and at a temperature between about 250° C. and about 300° C., methanol reacts with steam to produce H₂, CO₂ and a small amount of CO. As described above, the reforming catalyst typically also catalyzes the WGSR. If the reforming reactor per se has poor heat transfer performance, it will be impossible for heat energy at the heat source side of the reforming reactor to be transferred to the whole body of the reforming reactor, causing that a hot zone is formed near the heat source side of the reforming reactor and a cold zone is formed at regions away from the heat source. The cold/hot zones formed due to the poor heat transfer performance will cause a low reaction rate and a low conversion extent of the methanol steam reforming reaction in the cold zone and cause H₂ and CO₂ generated from the reforming reaction to react into CO and H₂O in the hot zone due to the over-high temperature, thereby degrading commercial value of the resulting hydrogen-containing gaseous mixture. To avoid this, the temperature distribution in the reforming reactor has become a great concern in design of the catalyst reactor, and it is highly desirable in the art to provide a reactor featuring superior heat transfer performance.

To improve heat transfer capability of the reforming reactor, all current efforts focus on how to enlarge a surface area for heat exchange in the reactor, including enlarging a surface area of the oxidizing catalyst bed of the exothermic oxidizing reaction that provides heat energy in the reforming reactor so as to transfer the heat energy generated from the exothermic oxidizing reaction to the reforming catalyst bed of the reforming reactor quickly, and/or enlarging a surface area of the reforming catalyst bed to quickly absorb the heat energy generated from the oxidizing reaction, thereby to avoid occurrence of hot/cold zones in the reactor which would otherwise degrade the content and/or quality of H₂ in the product.

Through continued research efforts, the present inventors have found that simply enlarging the surface area of the catalyst bed only delivers a very limited improvement effect, and enlarging the surface area excessively may even lead to an undesirable effect. Accordingly, the present invention provides a hydrogen generation device which enlarges the surface area of the reforming reactor under certain conditions and uses a material with a specific thermal conductivity as the material for fabricating the reforming reactor, thereby obtaining a reforming reactor having a superior thermal conductivity. This hydrogen generation device presents a desirable temperature distribution during the reaction and, when being used for the steam reforming reaction, provides a hydrogen-containing gaseous mixture of a low CO content which is of a great commercial value.

### SUMMARY OF THE INVENTION

An objective of the present invention is to provide a hydrogen generator essentially composed of a first medium, comprising:

a reforming zone for containing a reforming catalyst so as to perform a steam reforming reaction of a hydrogen-producing raw material to generate hydrogen;

a preheating zone; and

a heat source,

wherein the reforming zone, the preheating zone, and the heat source are arranged in such a way that the heat source provides the heat required by the preheating zone and the reforming zone, so that the hydrogen-producing raw material is firstly preheated in the preheating zone and then performs the steam reforming reaction in the reforming zone; and the reforming zone and the preheating zone are divided with the first medium by a shortest distance of at least 0.5 mm, wherein the first medium has a thermal conductivity (K) of at least about 60 W/m-K.

Another objective of the present invention is to provide a hydrogen generation device, comprising:

the hydrogen generator described above;

a heat exchanger; and

a de-CO element for oxidizing CO therein into CO₂ to reduce CO concentration,

wherein the hydrogen generator, the heat exchanger and the de-CO element are arranged in such a way that the product of the hydrogen generator conducts heat exchange with the hydrogen-producing raw material entered into the hydrogen generation device in the heat exchanger to increase the thermal efficiency of the device, so as to preliminarily heat the hydrogen-producing raw material before being entered into the preheating zone; and after the product of the hydrogen generator exits from the heat exchanger, it is then entered into the de-CO element to remove the CO contained therein.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a cross-sectional view of an embodiment of a hydrogen generator according to the present invention;

FIG. 2 is a cross-sectional view of another embodiment of the hydrogen generator according to the present invention;

FIG. 3 is a cross-sectional view of yet another embodiment of the hydrogen generator according to the present invention;

FIG. 4 is a cross-sectional view of still another embodiment of the hydrogen generator according to the present invention;

FIG. 5 is a cross-sectional view of an embodiment of the hydrogen generation device according to the present invention;

FIG. 6 illustrates the hydrogen yield when a hydrogen generation device of the present invention is used to produce a hydrogen-containing gaseous mixture;

FIG. 7 illustrates the CO content of the hydrogen-containing gaseous mixture measured when the hydrogen generation device of the present invention is used to produce the hydrogen-containing gaseous mixture;

FIG. 8 illustrates the comparison between voltage-current graphs measured when applying reformer gases produced by the hydrogen generation device of the present invention and general cylinder gases to a fuel cell respectively; and

FIG. 9 illustrates the test result of cell performance of a fuel cell that uses a reformer gas produced by the hydrogen generation device of the present invention.

### DESCRIPTION OF THE PREFERRED EMBODIMENT

Herein below, some embodiments of the present invention will be described in detail; however, the present invention may also be embodied in various different forms without departing from spirits of the present invention and shall not be construed to be limited to what described herein. For sake of clarity, dimensions of individual elements and regions may be exaggerated in the attached drawings but not drawn to the scale. Additionally, as used herein below, the term “parallel” is not merely limited to the sense of absolutely parallel, but may also include cases of not absolutely parallel without compromising effect of the present invention.

The hydrogen generator of the present invention is essentially composed of a first medium and comprises: a reforming zone for containing a reforming catalyst so as to perform a steam reforming reaction of a hydrogen-producing raw material to generate hydrogen, a preheating zone, and a heat source. The reforming zone, the preheating zone, and the heat source are arranged in such a way that the heat generated from the heat source is provided to the preheating zone and the reforming zone, so that the hydrogen-producing raw material is firstly preheated in the preheating zone and then performs the steam reforming reaction in the reforming zone; and the reforming zone and the preheating zone are separated by the first medium.

As well-known to people with ordinary skill in the art, to avoid a non-uniform temperature distribution in the reforming zone which would otherwise lead to cold/hot zones during the reforming reaction and compromise efficiency of the steam reforming reaction, the surface areas of the reforming zone and the catalyst bed thereof shall be made to be as large as possible so that the reforming zone can receive the heat transferred from the heat source quickly for use to perform the steam reforming reaction of the reforming catalyst and the hydrogen-producing raw material, thereby to improve the efficiency of the reforming reaction.

To enlarge the surface area and improve the reaction efficiency as far as possible, an approach that is commonly used is to fill the catalyst into tubes of a small diameter to shorten a distance between catalyst particulates and the tube wall, and enlarge the area of the tube wall so as to enlarge the area available for heat transfer. However, through continued research efforts, the present inventors have found that, it is impossible to deliver a desirable improvement as expected by simply enlarging the surface areas of the catalyst bed (i.e., the reforming zone), and the heat conductivity of the material of the reaction equipment must be enhanced at the same time in order to obtain a desired heat transfer rate within the reaction equipment. It has been found through a research that, in order to obtain the optimal heat transfer efficiency, the individual zones (preheating zone and reforming zone) in the hydrogen generator of the present invention must be separated with a first medium by a shortest distance of at least about 0.5 mm, and preferably at least about 1.0 mm. The first medium composing the hydrogen generator has a thermal conductivity (K) of at least about 60 W/m-K, preferably at least about 100 W/m-K, and more preferably at least about 200 W/m-K. In case the shortest distance between the individual zones is less than about 0.5 mm, the overall heat transfer efficiency would tend to degrade due to lack of sufficient medium of a high thermal conductivity between the individual zones, thereby compromising the hydrogen yield.

According to the present invention, the heat source that provides heat to the reforming zone and the preheating zone is not particularly limited and can be selected from a group consisting of a burner, a heating band, an electric heater, a hot bath, hot gas, a catalytic heater and combinations thereof. For example, the heat necessary for the reforming zone and the preheating zone can be provided directly by a burner, a catalytic heater or electric heater, or indirectly by absorbing the surplus heat generated from the adjacent heat generating element, such as electric equipments and vehicles. In some embodiments of the present invention, an oxidation zone can be arranged in the hydrogen generator to be used as a heat source so as to provide the heat necessary for the preheating zone and the reforming zone. In particular, the oxidation zone has a first oxidizing catalyst therein and is used for performing an exothermic oxidizing reaction to generate heat. In this case, each two of the reforming zone, the oxidation zone and the preheating zone are divided with the first medium by a shortest distance of at least 0.5 mm, wherein the first medium has a thermal conductivity (K) of at least about 60 W/m-K.

Without being bound to theory, any metal having a thermal conductivity (K) of no less than about 60 W/m-K may be used as the first medium in the hydrogen generator of the present invention. For example, at lease one selected from a group consisting of aluminum, an aluminum alloy, copper, a copper alloy and graphite may be used as the first medium, and preferably, an aluminum alloy or a copper alloy (e.g., brass or cupronickel (Ni/Cu)) is selected as the first medium. It should be confirmed that the reaction temperature involved is lower than the softening temperature of the selected material of the first medium.

The hydrogen-producing raw material for use in the present invention may be any material commonly used in a reforming reaction to produce hydrogen, for example, any material selected from a group consisting of C₁-C₁₂ hydrocarbons and their oxides, and combinations thereof. In an embodiment of the present invention, methanol is used to perform the steam reforming reaction. In this case, because the methanol steam reforming reaction has a low reaction temperature, an aluminum alloy having a softening temperature of above about 550° C. (e.g., Al-6061, which has a thermal conductivity of about 180 W/m-K) may be selected as the first medium of the hydrogen generator.

The reforming catalyst useful in the present invention is not particularly limited. For example, when the methanol steam reforming reaction is adopted, a catalyst selected from a group consisting of copper-zinc catalyst (CuOZnO/Al₂O₃), platinum catalyst (Pt/Al₂O₃), palladium catalyst (Pd/Al₂O₃) and combinations thereof may be used as the reforming catalyst.

In the case that an oxidation zone is used as the heat source for the hydrogen generator, the first oxidizing catalyst useful in the oxidation zone is also not particularly limited. For example, when the methanol oxidization reaction is adopted to provide all or a portion of heat energy necessary for the reforming reaction, a catalyst selected from a group consisting of platinum catalyst (Pt/Al₂O₃), palladium catalyst (Pd/Al₂O₃), platinum-cobalt catalyst (Pt—Co/Al₂O₃), boron nitride-promoted platinum catalyst (Pt-hBN/Al₂O₃, PBN) or boron nitride-promoted platinum-cobalt catalyst (Pt—Co-hBN/Al₂O₃) and combinations thereof may be used as the first oxidizing catalyst. In some embodiments of the present invention, the methanol oxidizing reaction is catalyzed by PBN to provide the heat energy necessary for the preheating and reforming reaction.

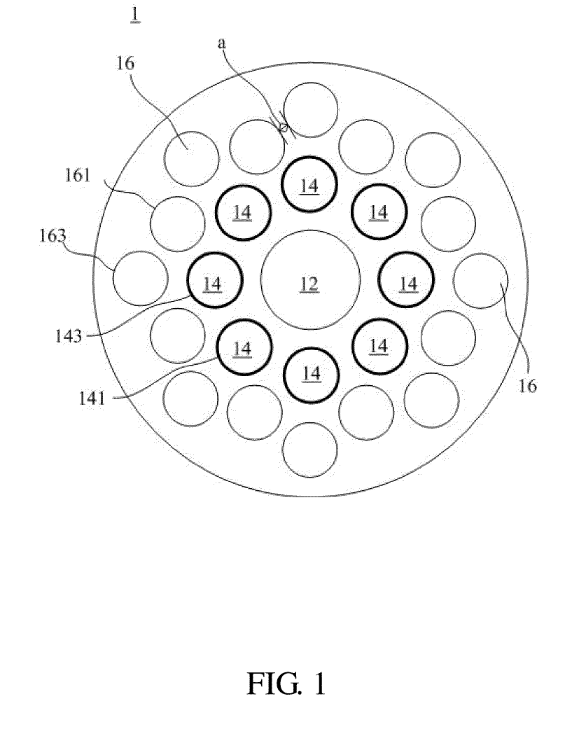

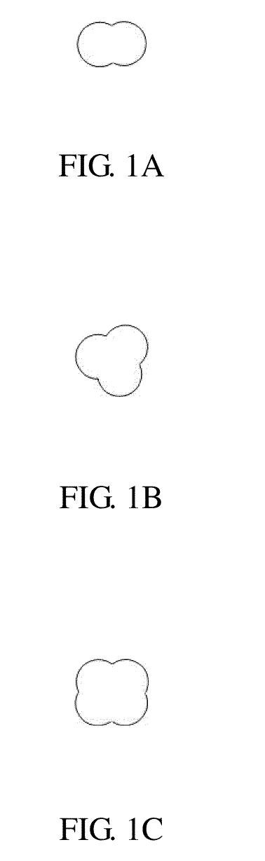

Referring to FIG. 1, a cross-sectional view of a cylindrical hydrogen generator 1 composed of a first medium according to the present invention is illustrated therein. The cylindrical hydrogen generator 1 comprises an oxidation zone 12, a preheating zone 14 and a reforming zone 16. As shown in FIG. 1, in this embodiment, the oxidation zone 12 is composed of a single channel; the preheating zone 14 is composed of eight channels that surround the oxidation zone 12 and are substantially parallel to each other, including a preheating zone inlet 141 and a preheating zone outlet 143; and the reforming zone 16, including a reforming zone inlet 161 and a reforming zone outlet 163, is composed of sixteen channels substantially parallel to each other. Any of the channels in the preheating zone 14 and the reforming zone 16 communicates with at least another channel of the same zone, but the inlet and the outlet of the same zone do not communicate with each other. Additionally, to avoid influence on the heat transfer effect of the hydrogen generator 1, the individual channels are separated from each other by a shortest distance a of at least about 0.5 mm, and preferably at least about 1.0 mm. The channel of the oxidation zone 12 is filled with a first oxidizing catalyst, while the channels of the reforming zone 16 are filled with a reforming catalyst.

According to the invention, the cross-sectional shape of the channels of the generator is not limited and may be in any geometric shape. For example, to improve the reaction efficiency, the circular channel in FIG. 1 may be replaced by a multi-circle clustered channel shown in FIG. 1A, 1B or 1C to shorten the distance between the tube wall and catalyst particulates (especially for the catalyst particulates positioned in the core of the channel), and also enlarge the surface area of the tube wall so as to increase the efficiency of heat transfer.

During the steam reforming reaction, a fuel used to be oxidized by the first oxidizing catalyst to release heat is fed into the oxidation zone 12 to perform an exothermic oxidizing reaction, which will provide heat necessary for the preheating zone 14 and the reforming zone 16. For example, a portion of the hydrogen-producing raw material (e.g., methanol) to be used in the steam reforming reaction may be mixed with the air as the fuel, which is then introduced into the oxidation zone 12 from an end of the channel thereof to perform the exothermic oxidizing reaction. Heat generated from the reaction is conducted to other zones through the first medium composing the hydrogen generator, while excessive heat is exhausted from the other end of the channel of the oxidation zone 12. The remaining portion of hydrogen-producing raw material, mixed with water (or water steam), is firstly introduced into the preheating zone 14 through the preheating zone inlet 141 and preheated therein by the heat transferred from the oxidation zone 12 through the first medium. Then, in a gaseous phase or mostly in a gaseous phase, the preheated mixture of the hydrogen-producing raw material and steam exits from the preheating zone 14 through the preheating zone outlet 143, enters into the reforming zone 16 through the reforming zone inlet 161, and flows in the channels of the reforming zone 16 where it is catalyzed by the reforming catalyst to fully perform the (methanol) steam reforming reaction. Finally, a hydrogen-rich gaseous mixture is obtained from the reforming zone outlet 163.

It shall be appreciated that, in the hydrogen generator of the present invention, the way in which an inlet communicates with an outlet is not particularly limited; for example, they may communicate with each other through a pipe made of the first medium or other materials.

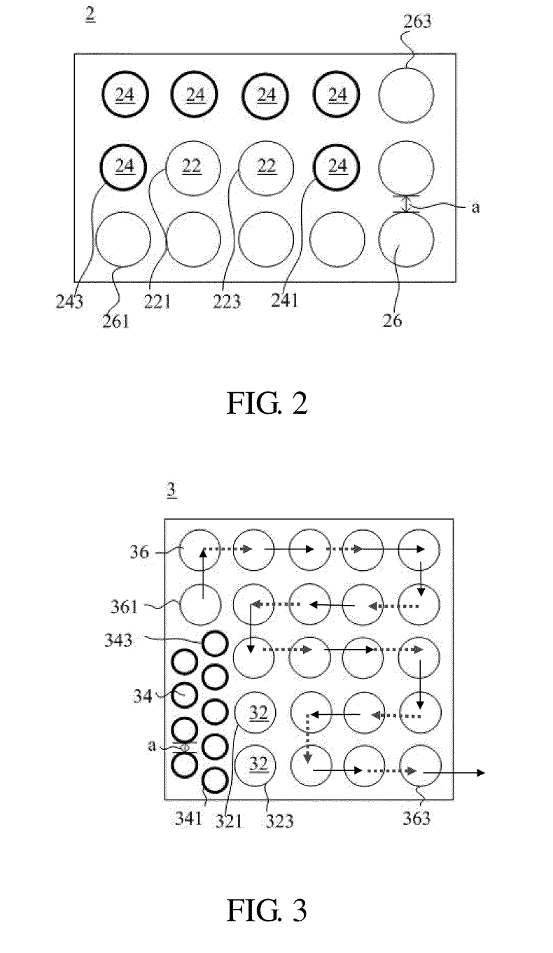

FIG. 2 is a cross-sectional view illustrating another embodiment of the hydrogen generator of the present invention, which is a rectangular hydrogen generator 2 composed of the first medium. The rectangular hydrogen generator 2 comprises an oxidation zone 22, a preheating zone 24 and a reforming zone 26. In this embodiment, the oxidation zone 22 is composed of two channels parallel to each other for use as an oxidation zone inlet 221 and an oxidation zone outlet 223 respectively; the preheating zone 24 is composed of six channels substantially parallel to and communicate with each other, including a preheating zone inlet 241 and a preheating zone outlet 243; and the reforming zone 26 is composed of seven channels substantially parallel to each other, including a reforming zone inlet 261 and a reforming zone outlet 263. Any of the channels in each of these zones communicates with at least another channel of the same zone, but the inlet and the outlet of the same zone do not communicate with each other. To avoid influence on the heat transfer effect of the hydrogen generator 2, the individual channels are separated from each other by a shortest distance a of at least about 0.5 mm, and preferably at least about 1.0 mm. Similarly, the oxidation zone 22 is filled with the first oxidizing catalyst, while the reforming zone 26 is filled with the reforming catalyst.

FIG. 3 is a cross-sectional view illustrating yet another embodiment of the hydrogen generator of the present invention, which is a rectangular hydrogen generator 3 composed of the first medium. The rectangular hydrogen generator 3 comprises an oxidation zone 32, a preheating zone 34 and a reforming zone 36. In this embodiment, the oxidation zone 32 is also composed of two channels parallel to each other for use as an oxidation zone inlet 321 and an oxidation zone outlet 323 respectively; the preheating zone 34 is composed of nine channels substantially parallel to each other, including a preheating zone inlet 341 and a preheating zone outlet 343; and the reforming zone 36 is composed of twenty channels substantially parallel to each other, including a reforming zone inlet 361 and a reforming zone outlet 363. Any of the channels in each of these zones communicates with at least another channel of the same zone, but the inlet and the outlet of the same zone do not communicate with each other. To avoid influence on the heat transfer effect of the hydrogen generator 3, the individual channels are separated from each other by a shortest distance a of at least about 0.5 mm, and preferably at least about 1.0 mm. Similarly, the oxidation zone 32 is filled with the first oxidizing catalyst, while the reforming zone 36 is filled with the reforming catalyst.

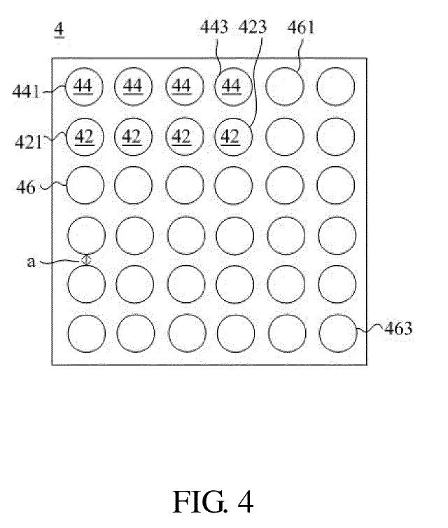

FIG. 4 is a cross-sectional view illustrating still another embodiment of the hydrogen generator of the present invention, which is a rectangular hydrogen generator 4 composed of the first medium. The rectangular hydrogen generator 4 comprises an oxidation zone 42, a preheating zone 44 and a reforming zone 46. In this embodiment, the oxidation zone 42 is composed of four channels parallel to each other, including an oxidation zone inlet 421 and an oxidation zone outlet 423; the preheating zone 44 is composed of four channels parallel to each other, including a preheating zone inlet 441 and a preheating zone outlet 443; the reforming zone 46 is composed of twenty eight (28) channels substantially parallel to each other, including a reforming zone inlet 461 and a reforming zone outlet 463. Any of the channels in each of these zones communicates with at least another channel of the same zone, but the inlet and the outlet of the same zone do not communicate with each other. To avoid influence on the heat transfer effect of the hydrogen generator 4, the individual channels are separated from each other by a shortest distance a of at least about 0.5 mm, and preferably at least about 1.0 mm. Similarly, the oxidation zone 42 is filled with the first oxidizing catalyst, while the reforming zone 46 is filled with the reforming catalyst.

The hydrogen-producing processes and methods of FIGS. 2-4 are substantially the same as those described with respect to the hydrogen generator 1 of FIG. 1, and thus will not be further described herein. To describe relationships among the channels of the present invention in more detail, FIG. 3 also illustrates flow directions of the gaseous mixture in the reforming zone 36, where the arrows depicted therein indicate the flow directions of the gaseous mixture in the reforming zone 36 of the reactor. More specifically, the solid arrows indicate that the two associated channels communicate with each other at an end of the hydrogen generator that is facing towards the reader, while the dashed arrows indicate that the two associated channels communicate with each other at the other end (i.e., the end that is away from the reader).

The hydrogen generator of the present invention is also able to provide a hydrogen gaseous mixture product of with low CO content for direct use in general fuel purposes, e.g., in boiler combustion.

The present invention further provides a hydrogen generation device, which comprises the hydrogen generator described above, a de-CO element and an optional heat exchanger. Each of the hydrogen generator, the de-CO element and the optional heat exchanger may be composed of the same or different media; for example, the same first medium that is used for the hydrogen generator or materials of a lower thermal conductivity (e.g., about 0.01 to about 30 W/m-K) may be used. Additionally, either direct connection/contact or connection through, for example, tubing may be made between the heat exchanger and the hydrogen generator and between the heat generator and the de-CO element.

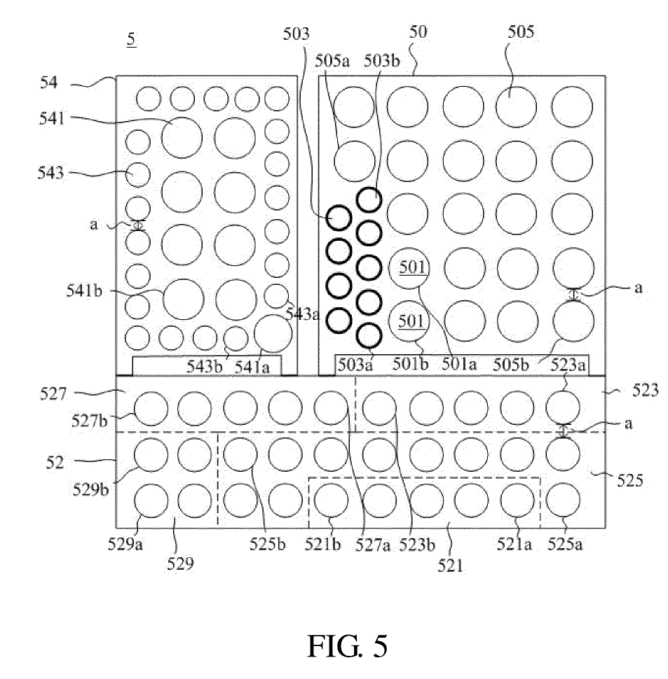

FIG. 5 is a cross-sectional view of an embodiment of the hydrogen generation device according to the present invention. The hydrogen generation device 5 comprises a hydrogen generator 50 composed of a first medium, a heat exchanger 52 and a de-CO element 54. The de-CO element 54 contains a second oxidizing catalyst therein for oxidizing CO therein into CO₂, thereby to further decrease the CO content in the resulting gaseous mixture, for example, down to below about 10 ppm. The heat exchanger 52 is connected with the hydrogen generator 50 and the de-CO element 54 respectively by the first medium. Additionally, no connection or contact is made between the hydrogen generator 50 and the de-CO element 54 so as to keep the hydrogen generator 50 and the de-CO element 54 at respective optimal reaction temperatures.

Substantially identical to that shown in FIG. 3, the hydrogen generator 50 comprises an oxidation zone 501, a preheating zone 503 and a reforming zone 505. In this embodiment, the oxidation zone 501 is composed of two channels parallel to each other for use as an oxidation zone inlet 501a and an oxidation zone outlet 501b respectively; the preheating zone 503 is composed of nine channels parallel to each other, including a preheating zone inlet 503a and a preheating zone outlet 503b; and the reforming zone 505 is composed of twenty (20) channels substantially parallel to each other, including a reforming zone inlet 505a and a reforming zone outlet 505b.

The heat exchanger 52 may be composed of any appropriate material, and in some embodiments of the present invention, is composed of the same first medium as the hydrogen generator 50. The heat exchanger 52 comprises a first channel zone 521, a second channel zone 523, a third channel zone 525, a fourth channel zone 527 and a fifth channel zone 529, which are connected with each other preferably through the first medium for heat transfer. The first channel zone 521 is composed of five channels parallel to each other, including a first inlet 521a and a first outlet 521b; the second channel zone 523 is composed of five channels parallel to each other, including a second inlet 523a and a second outlet 523b; the third channel zone 525 is composed of eleven (11) channels parallel to each other, including a third inlet 525a and a third outlet 525b; the fourth channel zone 527 is composed of five channels parallel to each other, including a fourth inlet 527a and a fourth outlet 527b; and the fifth channel zone 529 is composed of four channels parallel to each other, including a fifth inlet 529a and a fifth outlet 529b. Similarly, the shape of the channels of the heat exchanger according to the invention is not limited and may be provided in any known geometric shape as that of the hydrogen generator described above.

The de-CO element 54 comprises a CO-reaction zone 541 and a temperature-keeping zone 543. Each of the CO-reaction zone 541 and the temperature-keeping zone 543 is composed of one channel or a plurality of channels substantially parallel to each other, and in the case where a plurality of channels are adopted, any of the channels communicates with at least one another channel of the same zone. In the embodiment shown in FIG. 5, the CO-reaction zone 541 is composed of nine channels parallel to each other, including a reaction zone inlet 541a and a reaction zone outlet 541b, and each of the channels is filled with the second oxidizing catalyst. The temperature-keeping zone 543 is composed of twenty one (21) channels parallel to each other, including a temperature-keeping zone inlet 543a and a temperature-keeping zone outlet 543b. The temperature-keeping zone 543 is used to receive the hot gas from the oxidation zone outlet 501b of the hydrogen generator 50 to keep the CO-reaction zone 541 at an appropriate reaction temperature. The second oxidizing catalyst useful in the de-CO element 54 is not particularly limited. For example, at least one oxidizing catalyst selected from a group consisting of boron nitride-promoted platinum catalyst (Pt-hBN/Al₂O₃, PBN), platinum-cobalt catalyst (Pt—Co/Al₂O₃), platinum-ruthenium catalyst (Pt—Ru/Al₂O₃), boron nitride-promoted platinum-cobalt catalyst (Pt—Co-hBN/Al₂O₃), boron nitride-promoted platinum-ruthenium catalyst (Pt—Ru-hBN/Al₂O₃) and combinations thereof may be used as the second oxidizing catalyst. In some embodiments of the present invention, 1% Co/Al₂O₃, 1% Co, 1% hBN/Al₂O₃, or 1% Co, 1% hBN, 1% Ce/Al₂O₃ is used. Similarly, the cross-sectional shape of the channels of the de-CO element according to the invention is not limited and may be in any known geometric shape as that of the hydrogen generator described above.

Similarly, in the hydrogen generation device 5, any of the channels in each of these zones communicates with at least another channel of the same zone, but the inlet and the outlet of the same zone do not communicate with each other; and the individual channels are separated from each other by a shortest distance a of at least about 0.5 mm, and preferably at least about 1.5 mm. Furthermore, the way in which an inlet communicates with an outlet is not particularly limited. For example, they may communicate with each other through a pipe made of a material that is the same as or different from the first medium.

In the hydrogen generation device 5, the way in which the steam reforming reaction is performed in the hydrogen generator 50 is substantially identical to what described previously. However, the fuel (e.g., a mixture of methanol and air) for providing necessary heat for the steam reforming reaction is introduced into the channels of the second channel zone 523 through the second inlet 523a and then exits from the second outlet 523b before being introduced into the oxidation zone 501 through the oxidation zone inlet 501a to accomplish the oxidizing reaction; and the hydrogen-producing raw material (e.g., methanol and water steam) is introduced into the channels of the first channel zone 521 through the first inlet 521a and then exits from the first outlet 521b before being introduced into the preheating zone 503 through the preheating zone inlet 503a to be preheated.

Upon exiting from the reforming zone outlet 505b, the hydrogen-containing gaseous mixture obtained from the hydrogen generator 50 is introduced into the heat exchanger 52 via, for example, a pipe and then into the channels of the third channel zone 525 via the third inlet 525a for heat exchange therein. This can heat the hydrogen-producing raw material in the first channel zone 521 preliminarily and also preheat the fuel in the second channel zone 523. After the heat exchange, the hydrogen-containing gaseous mixture exits from the third channel zone outlet 525b into the CO-reaction zone 541 via the reaction zone inlet 541a so as to conduct the oxidizing reaction of CO therein, thereby obtaining a hydrogen-containing gaseous mixture which barely contains any CO.

Having transferred most of the heat to the reforming zone 505 via the first medium, the hot gas generated in the oxidation zone 501 of the hydrogen generator 50 exits from the oxidation zone outlet 501b and is divided into two portions which are introduced into the heat exchanger 52 and the de-CO element 54 through a pipe respectively. The portion of hot gas introduced into the heat exchanger 52 is further introduced via the fourth inlet 527a into the channels of the fourth channel zone 527 where heat exchange is accomplished to provide a heat source for the heat exchanger 52, and then the hot gas exits out of the fourth outlet 527b. Similarly, the heat provided by the oxidation zone 501 is also used to preliminarily heat the hydrogen-producing raw material in the first channel zone 521 and the fuel in the second channel zone 523. On the other hand, the portion of hot gas introduced into the de-CO element 54 is further introduced into the channels of the temperature-keeping zone 543 via the temperature-keeping zone inlet 543a to, during the process of flowing through the channels, provide heat necessary for keeping the de-CO element 54 at a temperature favorable for removing CO from the hydrogen-containing gaseous mixture. Then, this portion of hot gas exits out of the temperature-keeping zone outlet 543b, enters via the fifth zone inlet 529a into the fifth channel zone 529 where the remaining heat is provided to the heat exchanger 52, and finally exits out of the fifth zone outlet 529b. Here, the exhaust gas from the fourth outlet 527b and the fifth zone outlet 529b may be, for example, introduced into exhaust gas treatment equipment for necessary treatment.

The hydrogen-containing gaseous mixture provided by the hydrogen generation device of the present invention has an extremely low CO content which is comparable to that from a high purity hydrogen cylinder. Hence, the hydrogen-containing gaseous mixture can be used in fuel cells directly to deliver superior fuel cell performance comparable to that of fuel cells using a high purity hydrogen cylinder, which is of a great commercial value.

Herein below, the present invention will be further illustrated with reference to working examples.

### Example 1

### Hydrogen Production Test at a Rate of 200 Liters/Hour (L/hr)

The cylindrical hydrogen generator 1 shown in FIG. 1 was used, where an aluminum alloy (Al-6061) was used as the first medium composing the hydrogen generator 1, and the hydrogen generator 1 has a diameter of about 51 mm, a depth of about 50 mm and a shortest distance a between individual channels of about 1 mm. The oxidation zone 12 located at the center of the hydrogen generator 1 has a diameter of about 13 mm and a depth of about 50 mm, and was filled with about 9 g of PBN oxidizing catalyst therein; the eight channels of the preheating zone 14 have a diameter of about 7 mm and a depth of about 50 mm; and the sixteen (16) channels of the reforming zone 16 have a diameter of about 7 mm and a depth of about 50 mm, and were filled with about 43 g of reforming catalyst JM-51 therein.

Methanol was used as the hydrogen-producing raw material, and a mixture of methanol and air was used as a fuel for the oxidizing reaction. Firstly, at a rate of about 31.8 g/hr, methanol used as the fuel was mixed with air (at a molar ratio of O₂/C=about 1.65) and introduced into the oxidation zone 12 to perform the oxidizing reaction, resulting in a rise in the operating temperature of the hydrogen generator 1 to about 230° C. within about 332 seconds. Here, the fuel mixture was supplied at such a rate that hydrogen was produced at a rate of 200 L/hr. A difference between the highest temperature (at the edge of the channel of the oxidation zone 12) and the lowest temperature (at the edge of the hydrogen generator 1) of the hydrogen generator 1 was measured and recorded in Table 1. Then, methanol and water, in a liquid phase, were introduced into the preheating zone 14 via the preheating zone inlet 141 at a rate of about 96 g/hr and 60 g/hr (at a molar ratio of H₂O/C=1.1) respectively so as to be heated and vaporized during the process of flowing through the channels of the preheating zone 14. Then the vaporized methanol and water flowed out of the preheating zone 14 via the preheating zone outlet 143 into the channels of the reforming zone 16 via the reforming zone inlet 161, and during the process of flowing therethrough, experienced the steam reforming reaction in the presence of the reforming catalyst JM-51. Finally, the resulting hydrogen-containing gaseous mixture was captured at the reforming zone outlet 163 at a hydrogen yield of about 200 L/hr. The temperature distribution of the hydrogen generator 1 was measured, thermal efficiency of hydrogen and the total methanol was calculated, and a CO content of the resulting hydrogen-containing gaseous mixture was analyzed, with the results being recorded in Table 1.

### Example 2

### Hydrogen Production Test at a Rate of 200 L/h

The same hydrogen generator and process as those of Example 1 were used to perform the methanol steam reforming reaction. However, brass (70% Cu, 30% Zn, with a thermal conductivity of about 121 W/m-K) was used instead as the first medium composing the hydrogen generator 1, and the supplying rate of methanol in the fuel was adjusted in such a way that hydrogen was produced at a rate of 200 L/hr. The temperature distribution of the hydrogen generator 1 was measured, thermal efficiency of hydrogen and the total methanol was calculated, and a CO content of the resulting hydrogen-containing gaseous mixture was analyzed, with the results being recorded in Table 1.

### Comparative Example 3

### Hydrogen Production Test at a Rate of 200 L/hr

The same hydrogen generator and process as those of Example 1 were used to perform the methanol steam reforming reaction. However, stainless steel (with a thermal conductivity of about 15 W/m-K) was used instead as the first medium composing the hydrogen generator 1. As in Example 1, methanol and water were supplied in a liquid phase at a rate of about 96 g/hr and 60 g/hr respectively so as to produce hydrogen at a rate of 200 L/hr. The temperature distribution of the hydrogen generator 1 was measured, thermal efficiency of hydrogen and the total methanol was calculated, and a CO content of the resulting hydrogen-containing gaseous mixture was analyzed, with the results being recorded in Table 1.

TABLE 1

| | | Supplying rate | Difference between | Thermal effi- | |
|---|---|---|---|---|---|
| | Thermal | of fuel | the highest and | ciency of hydro- | CO Con- |
| | conductivity, | methanol, | the lowest tem- | gen and total | centration, |
| | (W/M-hr) | (g/hr) | perature, (° C.) | methanol (%)^{a} | (mole %) |
| Example 1 | 237 | 31.8 | 1 | 84.7 | 0.63 |
| Example 2 | 121 | 34.8 | 3 | 82.8 | 1.14 |
| Comparative | 15 | 55.2 | 120 | 71.6 | 1.37 |
| Example 3 | | | | | |

^{a}the thermal efficiency was calculated according to the following formula: (total combustion value of the hydrogen product/combustion value of total methanol supplied) × 100%, where hydrogen and methanol have a combustion value of 10,800 kJ/m³ and 19,944 kJ/m³. Taking Example 1 as an example, the thermal efficiency is (10,800 × 200/1,000)/(19,944 × (96 + 31.8)/1,000) = 2,160/2,548.8 = 84.7%.

As can be seen in Table 1, as compared to the hydrogen generator composed of stainless steel (Comparative Example 3), the hydrogen generator 1 used in Examples 1 and 2 of the present invention presented a much more uniform temperature distribution at the same supplying rate of the hydrogen-producing raw material, making it impossible to cause cold/hot zones during the steam reforming reaction, and also presented a significantly decreased CO concentration in the resulting hydrogen-containing gaseous mixture. Furthermore, although the hydrogen generators of Examples 1, 2 and Comparative Example 3 have the same size, shape and heat exchange area, the hydrogen generators of Examples 1, 2 required much less methanol for use as the fuel at the same hydrogen production rate of 200 L/hr, leading to a remarkably improved thermal efficiency. In other words, the hydrogen generators of Examples 1, 2 delivered a hydrogen production efficiency significantly higher than that of Comparative Example 3.

### Example 4

### Hydrogen Production Test at a Rate of 200 L/hr

The rectangular hydrogen generator 2 shown in FIG. 2 was used, where an aluminum alloy (Al-6061) was used as the first medium composing the hydrogen generator 2. The hydrogen generator 2 has dimensions of about 55 mm×about 34 mm×about 50 mm and a shortest distance a between individual channels of about 1.5 mm. The oxidation zone 22 of the hydrogen generator 2 has a channel diameter of about 9 mm and a depth of about 50 mm, and was filled with about 4 g of PBN oxidizing catalyst therein; the preheating zone 24 has a channel diameter of about 7 mm and a depth of about 50 mm; and the reforming zone 26 has a channel diameter of about 9 mm and a depth of about 50 mm, and was filled with about 29 g of reforming catalyst JM-51 in the channels thereof.

As in Example 1, methanol and water were used as the hydrogen-producing raw materials, and a mixture of methanol with air was used as a fuel for the oxidizing reaction. Here, methanol used as the fuel was mixed with air (at a molar ratio of O₂/C=about 1.65) at a rate of about 42.6 g/hr, and methanol and water in a liquid phase for use as the hydrogen-producing raw materials were supplied at a rate of about 96 g/hr and 60 g/hr (at a molar ratio of H₂O/C=1.1) respectively. The resulting hydrogen yield was about 200 L/hr and the thermal efficiency was 78.1%.

A difference between the highest temperature (230° C.) and the lowest temperature (228° C.) was measured to be 2° C. in the hydrogen generator 2, and a CO content of the resulting hydrogen-containing gaseous mixture was analyzed to be about 0.51 mole %.

As can be seen from the results of Examples 1, 2 and 4, because of the good heat transfer performance thereof, the hydrogen generator of the present invention presents much better uniformity in temperature distribution and higher thermal efficiency as compared to Comparative Example 3 even when the profile of the hydrogen generator is changed or arrangement of the reforming zone, oxidation zone and preheating zone is altered; and the resulting hydrogen-containing gaseous mixture has a significantly decreased content of CO.

### Example 5

### Hydrogen Production Test at a Rate of 1,000 L/hr

The rectangular hydrogen generator 3 shown in FIG. 3 was used, where an aluminum alloy (Al-6061) was used as the first medium composing the hydrogen generator 3. The hydrogen generator 3 has enlarged dimensions of about 76 mm×about 76 mm×about 140 mm and a shortest distance a between individual channels of at least about 1.9 mm. The oxidation zone 32 of the hydrogen generator 3 has a channel diameter of about 13 mm and a depth of about 140 mm, and was filled with about 22 g of PBN oxidizing catalyst therein; the preheating zone 34 has a channel diameter of about 7 mm and a depth of about 140 mm; and the reforming zone 36 has a channel diameter of about 13 mm and a depth of about 140 mm, and was filled with about 353 g of reforming catalyst JM-51 in the channels thereof.

As in Example 4, methanol and water were used as the hydrogen-producing raw materials, and a mixture of methanol with air was used as a fuel for the oxidizing reaction. Here, methanol and air used as the fuel were supplied in mixture at a rate of about 198 g/hr and 1,380 L/hr respectively, and methanol and water in a liquid phase for use as the hydrogen-producing raw materials were supplied at a rate of about 478 g/hr and about 300 g/hr (at a molar ratio of H₂O/C=1.1) respectively. The resulting hydrogen yield was about 1,000 L/hr and the thermal efficiency was 80.1%.

A difference between the highest temperature (237° C.) and the lowest temperature (230° C.) was measured to be 7° C. in the hydrogen generator 3. The CO content of the resulting hydrogen-containing gaseous mixture was analyzed to be about 0.51 mole %, with the remaining being H₂ and CO₂.

### Example 6

### Hydrogen Production Test at a Rate of 3,000 L/hr

The rectangular hydrogen generator 4 shown in FIG. 4 was used, where an aluminum alloy (Al-6061) was used as the first medium composing the hydrogen generator 4. The hydrogen generator 4 has enlarged dimensions of about 100 mm×100 mm×220 mm and a shortest distance a between individual channels of at least about 1 mm. The oxidation zone 42 of the hydrogen generator 4 comprised four channels having a diameter of about 15 mm and a depth of about 220 mm, and was filled with about 93 g of PBN oxidizing catalyst therein; the preheating zone 44 has a channel diameter of about 15 mm and a depth of about 220 mm; and the reforming zone 46 comprised twenty eight (28) channels having a diameter of about 15 mm and a depth of about 220 mm, and was filled with about 1,088 g of reforming catalyst JM-51 in the channels thereof.

As in Example 4, methanol and water were used as the hydrogen-producing raw materials, and a mixture of methanol with air was used as a fuel for the oxidizing reaction. Here, methanol and air used as the fuel were supplied in mixture at a rate of about 540 g/hr and about 3,300 L/hr respectively, and methanol and water in a liquid phase for use as the hydrogen-producing raw materials were supplied at a rate of about 1,428 g/hr and about 882 g/hr (at a molar ratio of H₂O/C=1.1) respectively. The resulting hydrogen yield was about 3,000 L/hr and the thermal efficiency was 83%.

A difference between the highest temperature (230° C.) and the lowest temperature (219° C.) was measured to be 11° C. in the hydrogen generator 4. The CO content of the resulting hydrogen-containing gaseous mixture was analyzed to be about 0.41 mole %, with the remaining being H₂ and CO₂.

As can be seen from the results of Examples 4 to 6, even when volume of the hydrogen generator of the present invention is enlarged remarkably to improve the yield of the hydrogen-containing gaseous mixture, the uniformity in temperature distribution and the thermal efficiency are still very excellent and the CO content of the resulting hydrogen-containing gaseous mixture is still kept at almost the same level. Additionally, it can be found by comparing Example 6 of the present invention and Comparative Example 1 that, even when having a volume tens of times larger than that of Comparative Example 1, the hydrogen generator 4 of Example 6 still presents much better uniformity in temperature distribution than that of Comparative Example 1. This result further reveals that commercial value of the hydrogen generator of the present invention is more prominent in cases where a large volume of hydrogen needs to be produced.

### Example 7

### Hydrogen Generation Device (at a Hydrogen Production Rate of 1,000 L/hr)

The hydrogen generation device 5 shown in FIG. 5 is used to further reduce the CO content of the gaseous product produced by the hydrogen generator of the present invention to such an extent that the gaseous product can be used for fuel cells. Here, an aluminum alloy (Al-6061) was used as the first medium. Dimensions and structure of the hydrogen generator 50 are just the same as those of Example 5, and thus will not be further described herein. The oxidation zone 52 has a channel diameter of about 10 mm and a depth of about 140 mm. The CO reaction zone 541 of the de-CO element 54 has a channel diameter of about 13 mm and a depth of about 140 mm, and the temperature-keeping zone 543 of the de-CO element 54 has a channel diameter of about 7 mm and a depth of about 140 mm. The CO reaction zone 541 was kept at a temperature of about 120° C. and was filled with about 90 g of cobalt-promoted PBN catalyst therein.

Likewise, methanol was used as the hydrogen-producing raw material, and a mixture of methanol with air was used as a fuel for the oxidizing reaction. Here, methanol and air used as the fuel were supplied in mixture at a rate of about 156 g/hr and about 1,200 L/hr respectively, methanol and water in a liquid phase for use as the hydrogen-producing raw materials were supplied at a rate of about 478 g/hr and about 294 g/hr, and air is supplied to the CO reaction zone 541 at a rate of 51.8 L/hr.

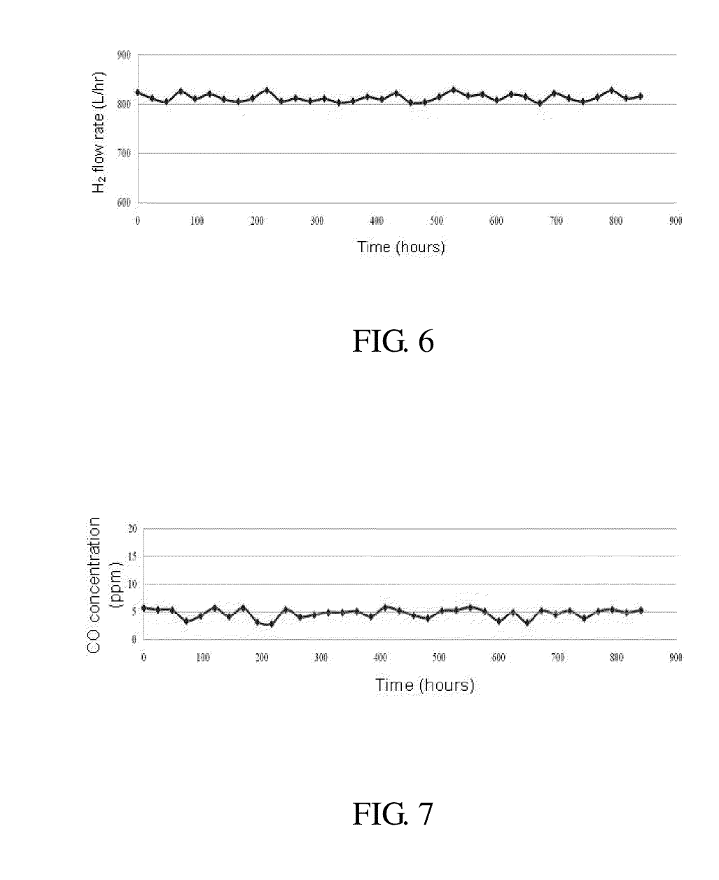

During the operation of the hydrogen generation device 5, the yield rate and CO content of the hydrogen-containing gaseous mixture were analyzed at the same time. The measurement results are shown in FIGS. 6 and 7, which indicate that the hydrogen yield was about 1,000 L/hr, the CO content was as low as 6 ppm and the thermal efficiency was 85%.

### Example 8

### Fuel Cell Test

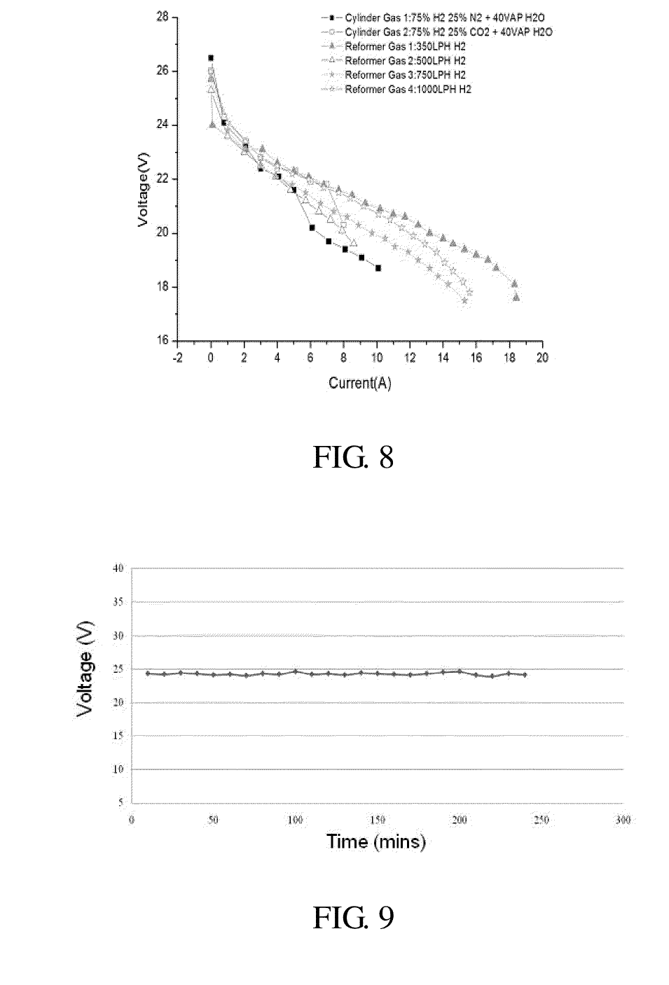

The hydrogen-containing gaseous mixture produced in Example 7 was applied to a fuel cell at different flow rates to test performance of the fuel cell, and comparison was made against general cylinder gases, with the test results being shown in FIG. 8.

As can be seen in FIG. 8, as it scarcely contains any CO, the hydrogen-containing gaseous mixture generated by the hydrogen generation device of the present invention may be applied to fuel cells directly and the fuel cells deliver good performance comparable to those using general cylinder hydrogen, which is of great commercial value.

To test stability of the fuel cell adopting hydrogen-containing gaseous mixture generated by the hydrogen generation device of the present invention as a fuel, the gaseous mixture was fed to a 700 W fuel cell stack at a flow rate of 200 L/hr and a load of 160 W was used to perform the stability test. The results are shown in FIG. 9. As can be seen in FIG. 9, the fuel cell adopting hydrogen-containing gaseous mixture generated by the hydrogen generation device of the present invention as a fuel exhibited superior stability, and the voltage thereof showed no drop even after a very long period of continuous use.

In summary, because of the good heat transfer performance thereof, the hydrogen generator of the present invention exhibits superior uniformity in temperature distribution during the steam reforming reaction, making it impossible to cause cold or hot zones in the hydrogen generator. Therefore, the resulting hydrogen-containing gaseous mixture has a very low CO content and can be used for general fuel purposes directly. Moreover, the hydrogen generation device of the present invention provides a hydrogen-containing fuel having a CO content of as low as 5 to 8 ppm, which can be used as a fuel source of fuel cells directly and is of great commercial value.

The above examples are only for illustrating the detailed technical contents and inventive features of the invention, but not limiting the scope thereof. Any modifications and replacements that can be easily carried out by people skilled in this field without departing from the characteristics and spirits of the invention should be covered in the scope of the invention. Thus, the scope of the invention is claimed as the following claims.

What is claimed is:

1. A hydrogen generator essentially composed of a first medium, comprising:
a reforming zone for containing a reforming catalyst so as to perform a steam reforming reaction of a hydrogen-producing raw material to generate hydrogen;
a preheating zone; and
a heat source,
wherein the reforming zone, the preheating zone and the heat source are arranged in such a way that the heat generated from the heat source is provided to the preheating zone and the reforming zone, so that the hydrogen-producing raw material is firstly preheated in the preheating zone and then performs the steam reforming reaction in the reforming zone; and the reforming zone and the preheating zone are divided with the first medium by a shortest distance of at least 0.5 mm, wherein the first medium has a thermal conductivity (K) of at least about 60 W/m-K.

2. The hydrogen generator of claim 1, wherein the heat source is an oxidation zone, said oxidation zone has a first oxidizing catalyst therein; and wherein each two of the reforming zone, the preheating zone and the oxidation zone are divided with the first medium by a shortest distance of at least 0.5 mm.

3. The hydrogen generator of claim 1, wherein the first medium has a thermal conductivity of at least about 100 W/m-K.

4. The hydrogen generator of claim 1, wherein the first medium has a thermal conductivity of at least about 200 W/m-K.

5. The hydrogen generator of claim 1, wherein the shortest distance is at least about 1.0 mM.

6. The hydrogen generator of claim 1, wherein each of the reforming zone and the preheating zone is composed of one channel or a plurality of channels parallel to each other; and any one of the channels is communicated with at least one another channel of the same zone and the channels of the hydrogen generator are divided with the first medium by a shortest distance of at least about 0.5 mm in the case where a plurality of channels are adopted.

7. The hydrogen generator of claim 6, wherein the channels of the hydrogen generator are divided with the first medium by a shortest distance of at least about 1.5 mm.

8. The hydrogen generator of claim 2, wherein each of the reforming zone, the preheating zone, and the oxidation zone is composed of one channel or a plurality of channels parallel to each other; and any one of the channels is communicated with at least one another channel of the same zone and the channels of the hydrogen generator are divided with the first medium by a shortest distance of at least about 0.5 mm in the case where a plurality of channels are adopted.

9. The hydrogen generator of claim 1, wherein the first medium is at lease one selected from a group consisting of aluminum, an aluminum alloy, copper, a copper alloy and graphite.

10. The hydrogen generator of claim 9, wherein the first medium is an aluminum alloy or a copper alloy.

11. The hydrogen generator of claim 1, wherein the hydrogen-producing raw material is selected from a group consisting of C₁-C₁₂ hydrocarbons and their oxides, and combinations thereof.

12. The hydrogen generator of claim 11, wherein the hydrogen-producing raw material is methanol.

13. The hydrogen generator of claim 1, wherein the reforming catalyst is selected from a group consisting of copper-zinc catalyst (CuOZnO/Al₂O₃), platinum catalyst (Pt/Al₂O₃), palladium catalyst (Pd/Al₂O₃) and combinations thereof.

14. The hydrogen generator of claim 2, wherein the first oxidizing catalyst is selected from a group consisting of platinum catalyst (Pt/Al₂O₃), palladium catalyst (Pd/Al₂O₃), platinum-cobalt catalyst (Pt—Co/Al₂O₃), boron nitride-promoted platinum catalyst (Pt-hBN/Al₂O₃, PBN) or boron nitride-promoted platinum-cobalt catalyst (Pt—Co-hBN/Al₂O₃) and combinations thereof.

15. A hydrogen generation device, comprising:
a hydrogen generator according to claim 1;
a heat exchanger; and
a de-CO element for oxidizing CO therein into CO₂,
wherein the hydrogen generator, the heat exchanger and the de-CO element are arranged in such a way that the product of the hydrogen generator conducts heat exchange with the hydrogen-producing raw material entered into the hydrogen generation device in the heat exchanger, so as to preliminary heat the hydrogen-producing raw material before being entered into the preheating zone; and after the product of the hydrogen generator exits from the heat exchanger, it is then entered into the de-CO element to remove the CO contained therein.

16. The hydrogen generation device of claim 15, wherein the heat exchanger is connected with the hydrogen generator and the de-CO element respectively by the first medium.

17. The hydrogen generation device of claim 15, wherein the de-CO element comprises a CO-reaction zone and a temperature-keeping zone; and the CO-reaction zone contains a second oxidizing catalyst.

18. The hydrogen generation device of claim 17, wherein each of the CO-reaction zone and the temperature-keeping zone is composed of one channel or a plurality of channels parallel to each other; and any one of the channels is communicated with at least one another channel of the same zone in the case where a plurality of channels are adopted.

19. The hydrogen generation device of claim 15, wherein the heat exchanger and the de-CO element are essentially composed of the first medium.

20. The hydrogen generation device of claim 17, wherein the second oxidizing catalyst is selected from a group consisting of boron nitride-promoted platinum catalyst (Pt-hBN/Al₂O₃, PBN), platinum-cobalt catalyst (Pt—Co/Al₂O₃), platinum-ruthenium catalyst (Pt—Ru/Al₂O₃), boron nitride-promoted platinum-cobalt catalyst (Pt—Co-hBN/Al₂O₃), boron nitride-promoted platinum-ruthenium catalyst (Pt—Ru-hBN/Al₂O₃) and combinations thereof.
